(19) United States
(12) Patent Application Publication
(10) Pub. No.: US 2012/0221384 A1
(43) Pub. Date: Aug. 30, 2012

(54) SYSTEM, METHOD, AND APPARATUS FOR ORGANIZING AND DISTRIBUTING APPS

(75) Inventors: Phani Bhushan Avadhanam, San Diego, CA (US); Xintian Li, Cupertino, CA (US)

(73) Assignee: QUALCOMM Innovation Center, Inc., San Diego, CA (US)

(21) Appl. No.: 13/037,093

(22) Filed: Feb. 28, 2011

(51) Int. Cl. G06Q 30/00; H04W 4/00

(52) U.S. Cl. 705/14.4; 455/414.1; 705/1.1

(57) ABSTRACT

Methods and apparatus for distributing processor-executable apps are disclosed. The method includes receiving an app from a developer, categorizing the app so as to associate the app with a particular category, combining the app with other apps that are associated with the particular category so as to create a collection of apps that are associated with the particular category, offering access to the collection of apps in return for compensation, and compensating the developer responsive to receiving the app.

### FIELD OF THE INVENTION

The present invention relates to mobile communication devices. In particular, but not by way of limitation, the present invention relates to the organization and distribution of apps.

### BACKGROUND OF THE INVENTION

There is an enormous market for applications, also referred to herein as apps, running on cell phones, smart phones, and other computing devices. The growth of the mobile apps industry has been phenomenal due to, among other factors, the success of wireless devices such as iPhones, iPads, BlackBerrys, Android-based computing devices, and Qualcomm's BREW, BMP and Snapdragon based devices.

There are wide varieties of applications that are used by millions of users on these devices. A typical usage model for these applications includes users going to a central location where all the apps are located/advertised, selecting the appropriate app, and trying the app for a fixed duration of time. If the users like the app, users may download and pay for the full version of the app. This model has a few inherent drawbacks that include difficult app discovery (from a users' perspective), unwanted apps consuming too much memory on user devices, and developers facing high maintenance costs (e.g., time consuming maintenance activities) and complex licensing/monetization issues.

With respect to app discovery, in the typical distribution model, users need to be aware of a particular app to find the app to try it out. For example, users typically have to search for a given app by various search criteria in the hopes of finding one that meets their needs, and many potentially viable apps are overlooked by users because of the difficulties associated with searching by the use of search terms.

If the users download a lot of apps (including apps offered as free downloads), and if they forget to delete the unwanted apps, premium memory space on the device is wasted because the unused applications take away memory space on the device, which leaves less memory available for future app downloads.

In addition, if a developer is an individual, that developer may be the primary interface for several individual users (e.g., several thousand individual users), and as a consequence, the developer may be overburdened with inquiries and app support issues. Moreover, the developers must transact with multiple users in connection with each distributed app; thus each developer faces the complexity of license management and the logistical challenges of monetizing an app when transacting with multiple individual users. As a consequence, improved apparatus and methods for distributing, marketing, and accessing applications are desired.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

In accordance with several embodiments, the invention may be characterized as a computing device that includes a network interface adapted to enable bidirectional communication to and from the computing device; a display configured to display content; a memory configured to store apps that are executable by the computing device; and an app management component. The app management component may be configured to remove unused apps from the memory, generate an app guide that includes a listing of app channels that a user of the computing device may subscribe to, wherein each of the app channels is associated with several apps. And in addition, the app management component effectuates digital rights management of apps that are downloaded to the memory of the computing device.

Another exemplary aspect of the invention may be characterized as a method for distributing apps. The method may include receiving an app from a developer, categorizing the app so as to associate the app with a particular app channel, combining the app with other apps that are associated with the particular app channel so as to create a collection of apps that are associated with the particular app channel, and offering access to the app channel in return for compensation. In addition, the developer is compensated responsive to receiving the app.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 illustrates a block diagram of an app distribution network according to several embodiments of the present invention;

FIG. 2 illustrates a block diagram depicting components of an exemplary app aggregator;

FIG. 3 is a flowchart depicting operations of aspects depicted in FIGS. 1 and 2;

FIG. 4 is a block diagram depicting an exemplary computing device;

FIG. 5 depicts an exemplary user interface that may be generated on the computing device of FIG. 4; and

FIG. 6 depicts exemplary components that may be used to realize the computing device depicted in FIG. 4.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Several embodiments of the present invention are directed to aggregating apps that are created by developers, and categorizing the aggregated apps into channels that users may subscribe to. In many variations of these embodiments, the aggregator of the apps operates to manage, after apps are developed, the branding, marketing, and financial aspects related to app deployment; thus easing many of the difficult aspects faced by app developers. In addition, for users, app discovery, app downloading, and app maintenance on computing devices (e.g., portable devices) is substantially improved.

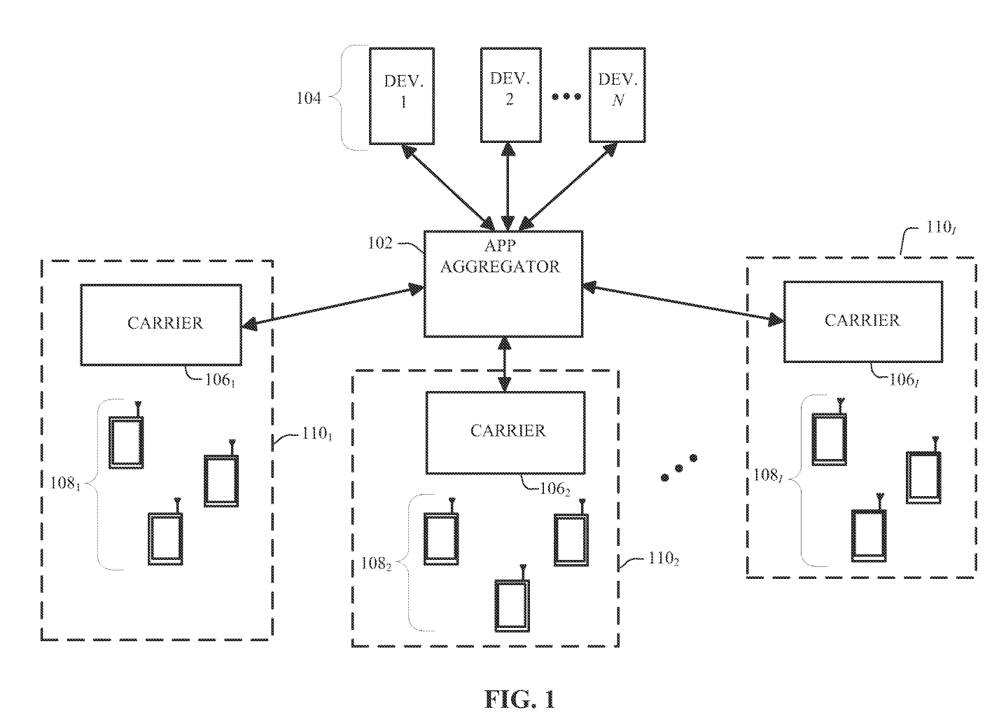

Referring first to FIG. 1, shown is an exemplary system according to several embodiments of the present invention. As shown, an app aggregator 102 is in communication with both N developers 104 and I carriers 106, and each of the carriers 106 is in communication with a collection of computing devices 108 in a corresponding service area 110.

The computing devices 108 may be any one of a variety of devices that are capable of communicating by network and capable of running apps. For example, each of the computing devices 108 may be realized as a smartphone, netbook, gaming device, PDA, tablet, or a laptop computer. In many embodiments, the computing devices 108 are capable of communicating with one or more wireless network types including, for example, 3G, 4G, WiFi, and WiMax networks.

In general, each of the app developers 104 develops one or more apps that are designed to operate on the computing devices 108. The apps for example, may include (without limitation) educational, financial, gaming, and utility apps. Each of the developers 104 may be financially independent from other ones of the developers 104, and each developer 104 may be a single person or a multi-person business entity. Although not discussed in detail herein because those of ordinary skill in the art are very familiar with app development, the developers 104 may utilize general-purpose computers that execute software (e.g., app development tools) to develop apps for a variety of types of computing devices 108 and operating systems.

But unlike typical app marketing and distribution models, the app developers 104 in this embodiment interact with the app aggregator 102 instead of potentially thousands of users; thus substantially reducing administrative activities and associated costs. This aspect of the exemplary embodiment is particularly beneficial to developers 104 that are individuals that do not have administrative resources to handle the complexity of license management and general monetization of the apps they develop.

The app aggregator 102 for example, generally operates to categorize, brand, and manage financial and logistical aspects of app distribution on behalf of the developers 104. As discussed further herein, each of the developers 104 may receive, from the app aggregator 102, one or more fees for developing an application; ongoing royalties (e.g., related to the number of downloads of an app); or a combination of upfront fees and royalties. But each of the developers 104 need only interact with the app aggregator 102 instead of multiple users or multiple carriers 106; thus time and costs (e.g., legal, administrative, and accounting costs) are saved. In addition, once the developers 104 have provided an app to the app aggregator 102, the developers 104 do not have to maintain servers to distribute apps or compensate third party entities to host app distribution; thus the app aggregator 102 relieves the developers 104 of many of the hassles of app marketing.

Moreover, the app aggregator 102 provides a more effective branding and marketing network than any one of the developers 104 could put in place. More specifically, in many variations of the exemplary system of FIG. 1, the app aggregator 102 operates specifically to brand collections of apps (e.g., that are categorized into channels) and create an awareness of the brands from the perspective of the users and carriers 106. In addition, each app benefits from the association of being offered amongst many other apps. As a consequence, developers benefit from the branding as well as the increased exposure that their apps will have by being associated with other apps.

As discussed further herein, in several variations of the system depicted in FIG. 1, the app aggregator 102 categorizes each app into one or more channels so that each app is bundled with other apps that have similar attributes and/or similar markets. And the app aggregator 102 then markets the channels to the carriers 106 and/or users of the computing devices 108.

As one of ordinary skill in the art will appreciate, each of the carriers 106 provides a communication service in a corresponding service area 110 to a collection of computing devices 108. For example, the carriers 106 may each provide cellular service using infrastructure (e.g., base stations and cell towers) that is well known to those of ordinary skill in the art; thus further details of the architecture and components of each of the carriers 106 is not provided.

But unlike existing carriers, each of the carriers 106 in the exemplary system depicted in FIG. 1 may offer app channels—instead of individual apps—to their customers. And as discussed further herein, each of the carriers 106 may further offer channels in a bundled package to their customers. In some variations, the app aggregator 102 may offer bundled channels to each of the carriers 106, and the carriers 106 may simply offer the same channel packages created by the app aggregator 102, and/or each of the carriers 106 may create their own packages of bundled channels. And each of the carriers 106 may simply bill the users for the channels and packages that the users subscribe to in the same monthly bill the carriers 106 already send to their customers.

In some implementations, one or more of the carriers 106 may also develop apps that are marketed, via the app aggregator 102, to other carriers 106 and/or users. In this way, users that obtain their communication services (e.g., cellular communication services) from a particular one of the carriers 106 may subscribe to a channel and/or package of channels that is developed by another one of the carriers 106.

In some variations, the app aggregator 102 receives periodic fee payments from each of the carriers 106 in return for providing particular app channels and/or packaged bundles of app channels. In other variations, the app aggregator 102 receives royalties that are based upon a number of downloads of each app. And in some variations, the app aggregator 102 receives both fees and royalties from one or more of the carriers 106.

In other variations, the app aggregator 102 financially interacts with the users of the computing devices 108 directly. In these variations for example, the app aggregator 102 offers subscriptions to the users directly, the users download the apps from the app aggregator 102, and the users pay the app aggregator 102 directly for subscriptions.

Although a single app aggregator 102 is depicted in FIG. 1, it is certainly contemplated that there may be several app aggregators 102, and each app aggregator 102 receives apps from developers 104 and markets app channels to one or more carriers 106. And in turn, each of the carriers 106 may contract with multiple app aggregators 102 so that each carrier 106 may offer channels provided by each of multiple app aggregators 102. In addition, it also contemplated that there may be multiple layers of app aggregators 102. For example, each successive layer of app aggregators 102 may aggregate channels offered by other app aggregators 102.

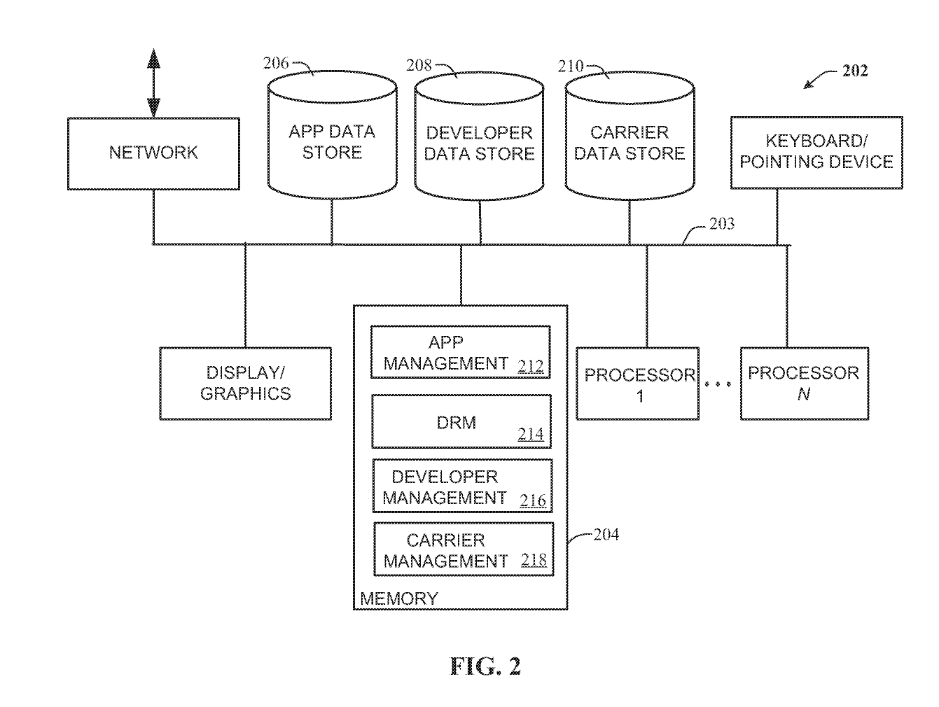

Referring next to FIG. 2, shown is a block diagram depicting components of an exemplary app aggregator 202. As shown, N processors in this embodiment (e.g., one or more processors) are coupled to a bus 203, and also coupled to the bus 203 are a memory 204, an app data store 206, a developer data store 208, a carrier data store 210, a keyboard/pointing device, a display/graphics component, and a network interface. In addition, an app management component 212, a digital rights management (“DRM”) component 214, a developer management component 216, and a carrier management component 218 are depicted as portions of executable code residing in the memory 204.

Each of the app data store 206, developer data store 208, and the carrier data store 210 may be realized by any device capable of holding substantial amounts of data, such as a hard drive, flash memory, compact disk (CD-ROM), DVD, or some other form of fixed or removable storage device. And one or more of the data stores 206, 208, 210 or other data store (not shown) in this embodiment may persistently store processor-readable code with instructions to effectuate processor-executable functions of the app aggregator 202 (e.g., the data stores 206, 208, 210 may store persistent copies of the app management component 212, the digital rights management (“DRM”) component 214, the developer management component 216, and the carrier management component 218).

The processors generally function to execute code corresponding to the app management component 212, the digital rights management (“DRM”) component 214, the developer management component 216, and the carrier management component 218 and process other information that resides in the memory 204, and may be any specific or general-purpose processor such as an INTEL x86 or POWERPC-compatible central processing unit (CPU), and may include multiple cores, and the memory 204 may be random access memory or nonvolatile memory. As one of ordinarily skill will appreciate, an operating system (e.g., LINUX or WINDOWS) may also reside in one or more of the data stores 206, 208, 210 and may execute from memory 204 and function (e.g., when executed by the processor) to enable the app management component 212, the digital rights management (“DRM”) component 214, the developer management component 216, and the carrier management component 218 to interoperate with the other components depicted in FIG. 2.

It should be recognized, however, that the depiction of the components in FIG. 2 is logical and is not intended to be an actual hardware diagram; thus the depicted components may be realized by common physical constructs or may be further distributed. For example, the app data store 206, the developer data store 208, and the carrier data store 210 may be realized by a single memory storage device, or they may be distributed among several local and remote (e.g., cloud based) storage devices. In addition, one of ordinary skill in the art will appreciate that the executable code corresponding to the logical depiction of the app management component 212, the digital rights management (“DRM”) component 214, the developer management component 216, and the carrier management component 218 may reside in disparate and distributed memory components and may not be identifiably separate from portions of other code.

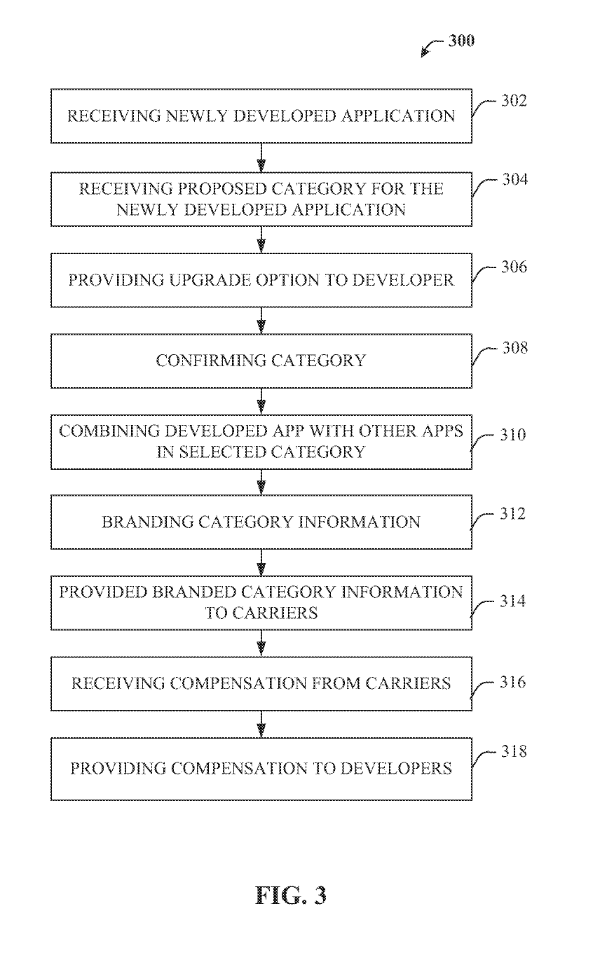

In general, the app data store 206 operates to store the apps that are created by developers 104, and it may include an index with information that includes channel information for each app. The app management component 212 generally operates to assist personnel with categorizing, managing, and accessing the apps that are stored in the app data store 206. As discussed with reference to FIG. 1, in connection with several embodiments of the present invention, apps are categorized and organized into channels based upon information received from the developers 104 and/or analysis by personnel associated with the app aggregator 202. Additional details relative to the app categorization process are described further herein with reference to FIG. 3.

In addition, the app management component 212, in connection with the DRM component 214, enables personnel to manage access-parameters and the values of the access parameters. For example, access-parameters may include a subscription level setting that restricts access to a particular app to a particular level of user subscription. In addition, the access-parameters may include time-bound subscription information, which limits access based upon a particular subscription term.

Although the app data store 206, app management component 212, and DRM management component 214 are depicted as part of the app aggregator 202, these components, or similar components, may be implemented and controlled by each of the carriers 106. For example, in some embodiments one or more carriers 106 may host the app data store 206, the app management component 212, and the DRM component 214 so that the carriers 106 maintain control of the apps and the app management.

The developer management component 216 generally operates to facilitate the management of relationships with the developers 104. For example, the developer management component 216 may be realized by a variety of available or customized software packages that enable data associated with each of the developers 104 to be tracked, stored (in the developer data store 208) and reported. For example, for each of the developers 104, several types of data may be maintained in the developer data store 208 including, without limitation, an identifier for each app developed by the developer 104; download data associated with each app; upgrade option data; and licensing data.

Using the data in the developer data store 208, the developer management component 216 may calculate any royalties and/or fees that are due to each individual developer 104. For example, licensing terms that compensate the developers 104 for each download of their apps in connection with download information for each app may be utilized to calculate and report royalties that are due to the developers 104.

The carrier management component 218 generally operates to facilitate the management of relationships with the carriers 106. For example, the carrier management component 218 may be realized by variety of software packages that enable data associated with each of the carriers 106 to be tracked, stored (in the carrier data store 210), and be reported. For example, for each of the carriers 106 that the app aggregator 202 has a relationship with, the carrier management component 218 may collect and store information (in the carrier data store 210) including, but not limited to, subscription information, the apps that are downloaded via each of the carriers 106, and financial agreements (e.g., licensing agreements). And among other information, any fees and/or royalties that are due from each of the carriers 106 may be calculated from this information.

Referring next to FIG. 3, shown is a flowchart depicting activity that may be carried out by the app aggregator 102, 202 described with reference to FIGS. 1 and 2. As shown, when a newly developed app is received (Block 302), in many implementations, a proposed category for the app is also received (Block 304). In some instances for example, an app aggregator decides at its sole discretion what category the app will be assigned to. In other instances, depending upon a relationship that the app aggregator has with a developer, the app aggregator may confer with the app developer to arrive at a category for the app.

For example, an app aggregator may provide each developer with a particular membership level that is selected from among several levels of available membership privileges. More specifically, each level of membership may provide the developer with an increased likelihood that their app is selected into a particular desired category. The level of membership that a developer attains may be based upon a variety of factors including a number of apps that the developer has developed; the success of the developer's apps; and a length of time the developer has had a relationship with the app aggregator. And as depicted in FIG. 3, in some implementations, an upgrade option is provided to the developer to increase the developer's chances that an app will be categorized into one or more “prominent” categories (e.g., a channel category that has more subscribers or subscribers that are more likely to purchase the app)(Block 306). A developer may upgrade, for example, by agreeing to a lower royalty; agreeing to receive a smaller fee from the app aggregator; or in some instances, the developer may agree to pay the app aggregator for the upgrade.

As shown in FIG. 3, once a developer and the app aggregator arrive at an agreement, the app aggregator confirms the category that the app will be placed within (Block 308), and the app is combined with other apps in the selected category (or categories)(Block 310).

As discussed with reference to FIG. 1, apps are branded (as a collection) and collectively marketed as a channel (Block 312). As a consequence, the app aggregator adds substantial value by creating an opportunity for apps to branded with other attention-provoking apps; thus providing exposure to a developer's app that any independently marketed app would not obtain.

For example, a particular category of apps or a bundle of related apps may be branded by the app aggregator and the carriers may also benefit by the favorable association that users have with the brand; thus in many embodiments, the branding information is provided (e.g., licensed) to carriers, and the carriers use the banding to market the channels.

As discussed in connection with FIG. 1 an app aggregator in many instances receives compensation from the carriers in return for the carrier's access to the channels (Block 316), and the app aggregator provides compensation to the developers (Block 318).

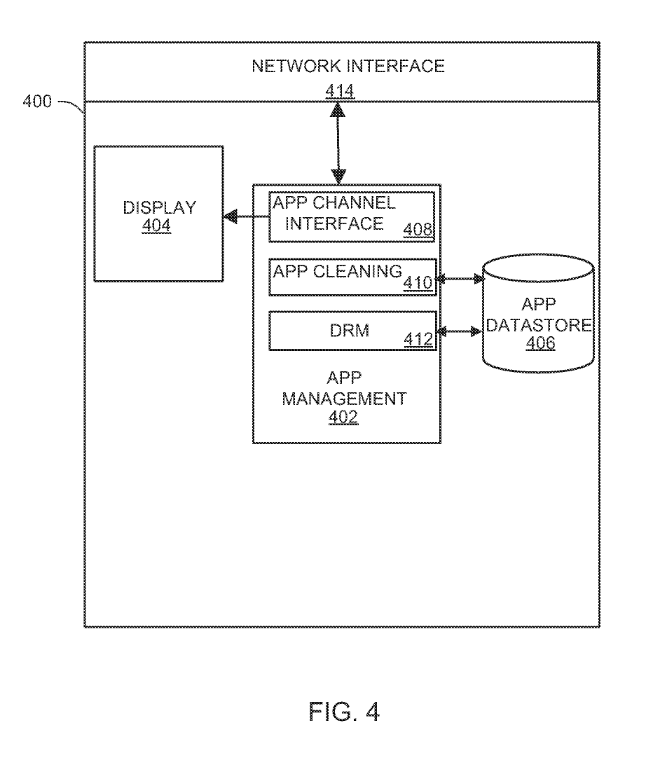

Referring next to FIG. 4, shown is a block diagram depicting the functional components of an exemplary computing device 400 according to an embodiment of the present invention. As shown, the computing device 400 includes an app management component 402 that is in communication with a display 404, an app data store 406, and a network interface 414. And the app management component 402 in this embodiment includes an app channel interface 408, an app cleaning component 410, and a digital rights management (“DRM”) component 412.

The illustrated arrangement of these components is logical, the connections between the various components are exemplary only, and the depiction of this embodiment is not meant to be an actual hardware diagram. And one of ordinary skill in the art will readily appreciate that the depicted components may be realized by a combination of hardware and software, and can be combined, or further separated and sub-divided, in an actual implementation. In addition, the components can be connected in a variety of ways without changing the basic operation of the system. Moreover, components may be removed and/or supplemented so that more or less components can be utilized in any particular implementation.

The app management component 402 generally functions to manage access to remote apps, and manage the apps once downloaded via the network interface 414. As shown, the app channel interface 408 is in communication with the network interface 414 and the display 404, and the app channel interface 408 in connection with the display 404 graphically provides an app guide for the user of the computing device 400.

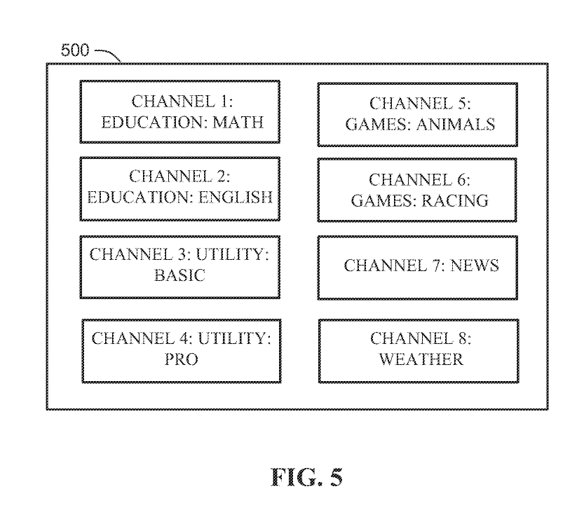

Referring briefly to FIG. 5, for example, shown is an exemplary app guide 500 that includes selectable buttons for each of several separate channels, and each of the channels includes a set of apps. Unlike prior app distribution systems, users subscribe to one or more of the depicted channels, and each of the channels includes a set of apps that are associated by one or more common attributes.

Although it is contemplated that channel-based app guides may vary from the depicted example in FIG. 5, the app guide 500 in FIG. 5 is formatted to include a category name, and in some variations a sub-category. As shown in FIG. 5, Channel 1 is categorized as an Education Channel and the subcategory Math is also shown in the app guide for Channel 1.

As discussed above, in many embodiments the app aggregator (e.g., app aggregator 102, 202) and/or carriers (e.g., the carriers 106) may bundle channels into channel packages that are offered on a subscription basis. For example, an Elementary Education package may include Channel 1, Channel 2, Channel 3, and Channel 5, which are channels that are more likely to interest a particular group of users (e.g., children in elementary school and parents of children in elementary school). As another example, a Business package may include Channel 4, Channel 7, and Channel 8, which are channels that are more likely to interest business people.

Subscription packages may also include selections of channels from different packages. For example, a selection of apps from an Education channel may be combined with selected apps from a Family Entertainment category. This combined package may be of interest to a family as a whole because some family members may be interested in the apps that relate to education and other family members may be interested in the apps that relate to games. As another example, a package may be offered to subscribers that includes a selection of apps from a Finance channel, a Personal Office channel, and a Sports channel.

In addition, channels and/or packages may be branded according to particular market segments. As a consequence, a particular brand (e.g., identified by a particular logo, trademark, or other unique branding aspect) will attract particular people based upon the types of apps that the brand is known for. For example, apps may be branded according to different levels of quality so as to create an association between each brand and an expected level of quality. As another example, a particular brand may be associated with apps that business people are more likely to be attracted to, and another brand may be associated with apps that educators are attracted to. In addition, branding may also be utilized in connection with the marketing of free channels, but it should be recognized that many embodiments of the present invention need not utilize branding techniques at all.

Although not depicted in FIG. 5, when a user selects any one of the channels, the app channel interface 408 may generate another display screen that includes channel subscription price, which may be set by a carrier or an app aggregator based upon the apps, and quantity of apps that are available in the channel. In addition, information about whether the channel is available as part of a package subscription may also be presented to the user, and information about whether the channel (or selected apps therefrom) may be used for a trial period may also be presented. Parental guidance information may also be provided to the user in addition to any other channel specific information.

Referring again to FIG. 4, the app management component 402 includes an app cleaning component 410 that is generally configured to remove apps from the app data store 406 to prevent unused or undesired apps from occupying memory space on the computing device 400. In this way, valuable memory space is not wasted and additional memory space is made available for future downloads. In some modes of operation for example, apps are removed if the app is not used within a specific period of time after the app is downloaded. In other modes of operation, apps that are not accessed for a certain length of time are removed. And in connection with these modes of operation, a user may be informed and/or prompted to initiate the removal of an app before the app is removed.

The DRM component 412 generally operates to carry out the digital rights management schemes that are initiated by an app aggregator (e.g., the app aggregator 102, 202) and/or carriers (e.g., carriers 106). For example, the DRM component 412 may disable apps that are tested on a trial basis after the initial trial period has ended. In addition, many subscriptions may be time-bound subscriptions, which may be defined in terms of monthly, weekly, annual or other time-defined terms.

In some variations of the embodiment depicted in FIG. 4, apps may be hosted remotely by a hosting entity (e.g., by a carrier or app aggregator) and run over the network (e.g., a 4G or other high speed network) that couples the computing device 400 with the hosting entity. In these variations, the app datastore 406, app cleaning component 410, and DRM component 412 may be optional components.

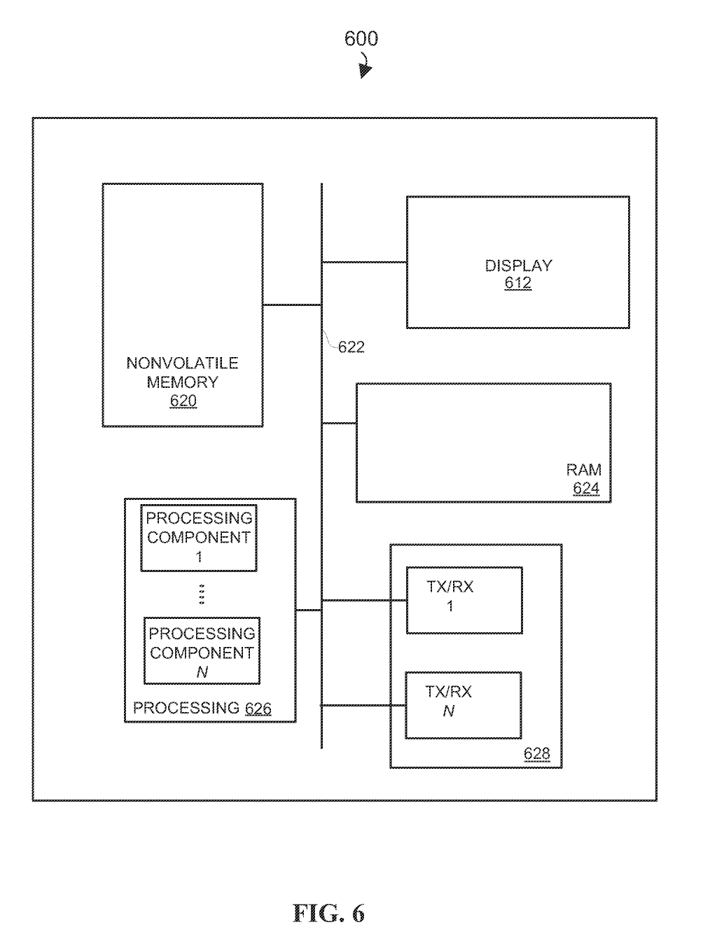

Referring next to FIG. 6, shown is a block diagram depicting physical components of an exemplary computing device 600 that may be utilized to realize the computing device 400 described with reference to FIG. 4. As shown, the computing device 600 in this embodiment includes a display portion 612, and nonvolatile memory 620 that are coupled to a bus 622 that is also coupled to random access memory (“RAM”) 624, a processing portion (which includes N processing components) 626, and a transceiver component 628 that includes N transceivers. Although the components depicted in FIG. 6 represent physical components, FIG. 6 is not intended to be a hardware diagram; thus many of the components depicted in FIG. 6 may be realized by common constructs or distributed among additional physical components. Moreover, it is certainly contemplated that other existing and yet-to-be developed physical components and architectures may be utilized to implement the functional components described with reference to FIG. 6.

This display portion 612 generally operates to provide a presentation of content to a user, and in several implementations, the display is realized by either an LCD or an OLED display. In general, the nonvolatile memory 620 functions to store (e.g., persistently store) data and executable code including code that is associated with the functional components of the app management component 402 described with reference to FIG. 4. In some embodiments for example, the nonvolatile memory 620 includes bootloader code, modem software, operating system code, file system code, and code to facilitate the implementation of one or more portions of the app channel interface 408, the app cleaning component 410, and the digital rights management (“DRM”) component 412.

In many implementations, the nonvolatile memory 620 is realized by flash memory (e.g., NAND or ONENAND memory), but it is certainly contemplated that other memory types may be utilized as well. Although it may be possible to execute the code from the nonvolatile memory 620, the executable code in the nonvolatile memory 620 is typically loaded into RAM 624 and executed by one or more of the N processing components in the processing portion 626.

The N processing components in connection with RAM 624 generally operate to execute the instructions stored in nonvolatile memory 620 to effectuate the functional components depicted in FIG. 4. As one of ordinarily skill in the art will appreciate, the processing portion 626 may include a video processor, modem processor, DSP, graphics processing unit (GPU), and other processing components.

The depicted transceiver component 628 includes N transceiver chains, which may be used for communicating with external devices via wireless networks. Each of the N transceiver chains may represent a transceiver associated with a particular communication scheme.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A computing device, the computing device comprising:
a network interface adapted to enable bidirectional communication to and from the computing device;
a display configured to display content;
a memory configured to store apps that are executable by the computing device; and
an app management component configured to:
remove unused apps from the memory;
generate an app guide that is displayable on the display, the app guide including a listing of app channels that a user of the computing device may subscribe to, each of the app channels is associated with a plurality of apps; and
effectuate digital rights management of apps that are downloaded to the memory.

2. The computing device of claim 1, wherein the app management component is configured to effectuate an end to a time-bound subscription so that apps associated with the time-bound subscription are no longer executable.

3. The computing device of claim 1, wherein the app guide includes subscription-pricing information for each of the app channels that indicates a term and price for a subscription to each of the app channels.

4. The computing device of claim 1, wherein each listing in the listing of the app channels conveys a particular category of app types.

5. A method for distributing apps, the method comprising:
receiving an app from a developer;
categorizing the app so as to associate the app with a particular app channel;
combining the app with other apps that are associated with the particular app channel so as to create a collection of apps that are associated with the particular app channel;
offering access to the particular app channel in return for compensation; and
compensating the developer responsive to receiving the app.

6. The method of claim 5, including:
offering a plurality of membership levels to the developer; and
categorizing the app based upon a membership level of the developer.

7. The method of claim 6, including offering an upgrade to the developer to upgrade a membership level of the developer.

8. The method of claim 5, including:
branding the particular app channel as a particular brand of app channel; and
marketing the particular app channel to a plurality of carriers as the particular brand of app channel, each of the carriers is a cellular service provider to a plurality of cellular-service subscribers.

9. The method of claim 8, including:
bundling a plurality of app channels together as an app channel package; and
marketing the app channel package to the carriers.

10. A system for distributing apps, the system including:
means for receiving an app from a developer;
means for categorizing the app so as to associate the app with a particular app channel;
means for combining the app with other apps that are associated with the particular app channel so as to create a collection of apps that are associated with the particular app channel;
means for offering access to the particular app channel in return for compensation; and
means for compensating the developer responsive to receiving the app.

11. The system of claim 10, including:
means for offering a plurality of membership levels to the developer; and
means for categorizing the app based upon a membership level of the developer.

12. The system of claim 11, including means for offering an upgrade to the developer to upgrade a membership level of the developer.

13. The system of claim 10, including:
means for branding the particular app channel as a particular brand of app channel; and
means for marketing the particular app channel to a plurality of carriers as the particular brand of app channel, each of the carriers is a cellular service provider to a plurality of cellular-service subscribers.

14. The system of claim 13, including:
means for bundling a plurality of app channels together as an app channel package; and
means for marketing the particular app channel package to the carriers.

15. A non-transitory, tangible computer readable storage medium, encoded with processor readable instructions to perform a method for obtaining web content on a mobile device, the method comprising:
receiving an app from a developer;
categorizing the app so as to associate the app with a particular app channel;
combining the app with other apps that are associated with the particular app channel so as to create a collection of apps that are associated with the particular app channel;
offering access to the particular app channel in return for compensation; and
compensating the developer responsive to receiving the app.

16. The non-transitory, tangible computer readable storage medium of claim 15, the method including:
offering a plurality of membership levels to the developer; and
categorizing the app based upon a membership level of the developer.

17. The non-transitory, tangible computer readable storage medium of claim 16, the method including offering an upgrade to the developer to upgrade a membership level of the developer.

18. The non-transitory, tangible computer readable storage medium of claim 15, the method including:
branding the particular app channel as a particular brand of app channel; and
marketing the particular app channel to a plurality of carriers as the particular brand of app channel, each of the carriers is a cellular service provider to a plurality of cellular-service subscribers.

19. The non-transitory, tangible computer readable storage medium of claim 18, the method including:
bundling a plurality of app channels together as an app channel package; and
marketing the app channel package to the carriers.
